(19) United States
(12) Patent Application Publication
(10) Pub. No.: US 2013/0069513 A1
(43) Pub. Date: Mar. 21, 2013

(54) Drawer Locking Device

(71) Applicant: Edward Pierre Torrens, Tampa, FL (US)

(72) Inventor: Edward Pierre Torrens, Tampa, FL (US)

(21) Appl. No.: 13/612,604

(22) Filed: Sep. 12, 2012

Related U.S. Application Data
(60) Provisional application No. 61/573,752, filed on Sep. 12, 2011.

(51) Int. Cl. E05B 9/00

(52) U.S. Cl. CPC E05B 9/002
USPC 312/333

(57) ABSTRACT

A drawer locking device comprised of two rectangular plates. One of these plates is a mounting base and has an eye loop protruding from the center of the plate. The actual hole is adjacent to the plate itself. This plate also has four countersunk screw holes, with two located on each side of the plate, as well as two locking pin holes, with one located on each side of the plate. The second plate is a secure base lock cover. This plate has two locking pins that are welded onto the plate. One pin is located on each side off the plate. This plate also has a circular hole in the center of the plate where the protruding eye loop on the mounting base passes through when placing the secure base lock cover onto the mounting base.

### CROSS-REFERENCE TO RELATED APPLICATIONS

This application claims the benefit of Provisional Patent Application Ser. No. 61/573,752, filed Sep. 12, 2011 by the present inventor, which is incorporated by reference.

### BACKGROUND OF THE INVENTION

1. Field of the Invention

This invention relates generally to drawer locking devices and more particularly pertains to a new drawer locking device for locking single drawer units.

2. Description of the Prior Art

The use of drawer locking devices is known in the prior art. U.S. Pat. No. 2,255,402 describes a traditional cam lock with a cam lever mounted at the end of the cylinder. Another type of drawer locking device is U.S. Pat. No. 6,874,825, which describes a device with a panel and an attached plate which may be rotated over an edge of a drawer to secure it.

While these devices generally fulfill their respective, particular objectives, this drawer locking device is a much-needed improvement from these devices. Specifically, this device is simpler and more secure than the prior art. The present inventor has been a locksmith for 40 years and through this extensive experience has witnessed the weaknesses of the prior art. The traditional cam lock, for example, which is commonly used to lock drawers, typically has a cam lock cylinder unit with a metal blade or arm called a cam that rotates when the key is turned. The metal blade on these devices is usually rather thin and after substantial usage the device becomes less secure. The present invention, by contrast, is more secure because after the user places the secure base lock cover onto the mounting base, the user would secure a padlock onto the padlock eye loop. In addition, the mounting base is mounted onto either side or onto the top of the drawer with four countersunk screws and the locking pins on the secure base lock cover are welded onto said secure base lock cover. Therefore, barring an unwanted individual gaining access to the padlock key, it would be extraordinarily difficult, if not impossible, to break into the drawer and obtain access to its contents. The present invention will be particularly valuable for securing high-value or hazardous contents such as medications or toxic materials.

There is also a market need for a simpler drawer locking device. Much of the existing prior art is rather complex. The present invention is very simple, with the mounting base and the secure base lock cover being the two primary components. The present invention does not require any electricity and does not contain any electronic components that would possess the risk of failure. The present invention is a simpler, more secure alternative to the prior art.

### SUMMARY OF THE INVENTION

The present invention comprises a unique drawer-locking device that is combined with the use of a single conventional padlock, wherein the locking device can be secured to either the left or right side of the drawer or onto the top of the drawer. The padlock is placed on the padlock eye loop to safely secure the contents of the drawer. This locking device is particularly well fit for single-drawer units.

The present invention consists of two components. One component is a mounting base, which has a padlock eye loop where the conventional padlock is to be secured. All four corners on the mounting base are rounded. The mounting base contains four countersunk screw holes, with two on each side of the mounting base. These four countersunk screw holes are the holes through which the countersunk screws are installed in order to secure the mounting base onto a drawer. The countersunk screws are concealed when the secure base lock cover is placed onto the mounting base. The mounting base also has two locking pin holes. These are the holes in which the locking pins pass after the secure base lock cover is placed onto the mounting base. The mounting base also has a padlock eye loop on it. The padlock eye loop is where the padlock is secured after the secure base lock cover has been placed on the mounting base.

The second component is a secure base lock cover that has two locking pins welded in place. All four corners on the secure base lock cover are rounded. The secure base lock cover has a circular hole in its center and when the secure base lock cover is placed on the mounting base, the padlock eye loop on the mounting base passes through this circular hole, and a padlock is then installed on the padlock eye loop and the drawer locking device is in a fully locked position.

In order to use the present invention to lock a drawer, one would drill four holes into either side or the top of a drawer so that the holes correspond with the countersunk screw holes in the mounting base. Then you would drill the two locking pin holes through the drawer so that the locking pins would pass through the mounting base. Then the installer would mount the mounting base onto the drawer by screwing four countersunk screws through the countersunk screw holes and through the drawer.

After the mounting base is properly mounted onto the side of the drawer, the secure base lock cover would be placed on top of the mounting base so that the padlock eye loop passes through the hole for eye loop on the secure base lock cover. The locking pins on the secure base lock cover pass through the two locking pin holes on the mounting base. Then a padlock would be placed on the padlock eye loop in order to secure the contents contained inside of the drawer.

There has thus been outlined, rather broadly, the more important features of the present invention in order that the detailed description thereof that follows may be better understood, and in order that the present contribution to the art may be better appreciated.

The objects of the invention, along with the various features of novelty which characterize the invention, are pointed out with particularity in the claim annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a drawer locking device according to the present invention.

FIG. 2 is a side view showing the present invention installed onto a drawer and the secure base lock cover releasably placed onto the installed mounting base.

### DESCRIPTION OF THE PREFERRED EMBODIMENT

With reference now to the drawings, a new drawer locking device embodying the principles and concepts of the present invention and generally designated by the reference numeral 1 will be described.

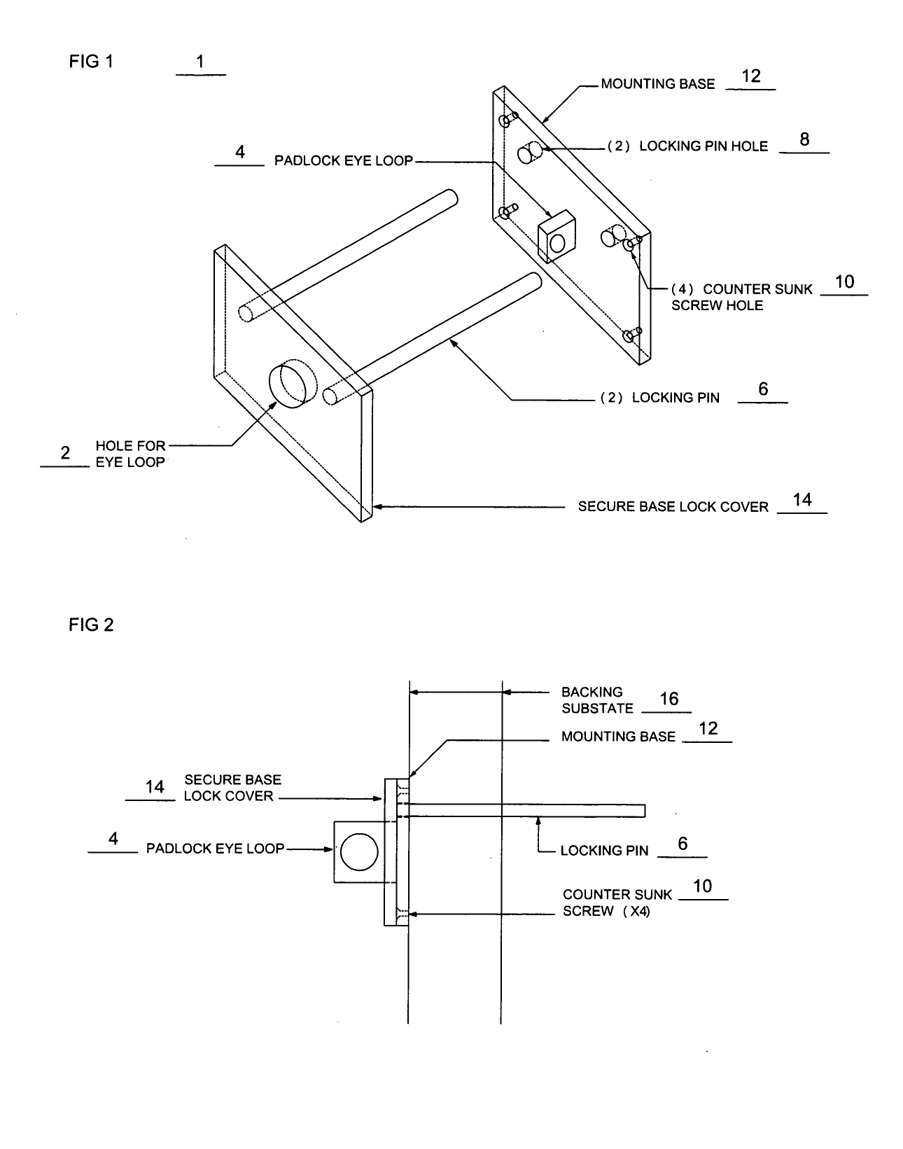

As illustrated in FIGS. 1 and 2, the drawer locking device generally comprises a mounting base (12) and a secure base lock cover (14). The mounting base (12) contains four countersunk screw holes (10), with two located on the left side off the mounting base (12) and the other two located on the right side of the mounting base (12). In addition, the mounting base (12) contains two locking pin holes (8), with one located on the left side of the mounting base (12) and the other located on the right side of the mounting base (12). Further, the mounting base (12) contains a padlock eye loop (4) that is welded onto the center of the mounting base (12). After insertion of the placement of the secure base lock cover (14) onto the mounting base (12), with the locking pins (6) passing through the locking pin holes (8), a conventional padlock is placed on padlock eye loop (4) to secure the contents off the drawer.

The secure base lock cover (14) is the same size in length, width, and diameter as the mounting base (12). The secure base lock cover (14) contains two locking pins (6). These two locking pins (6) are welded onto the secure base lock cover (14). One locking pin is located on the left side of the secure base lock cover (14) and the other is located on the right side of the secure base lock cover (14). As stated above, the locking pins (6) are welded onto the secure base lock cover (14) and would be extraordinarily difficult to remove from the secure base lock cover (14). This is just one feature of the present invention making it such a secure locking device. The secure base lock cover (14) also contains a hole for eye loop (2), located at the center of the secure base lock cover (14). The hole for eye loop (2) is a round hole and is where the padlock eye loop (4) passes through after the secure base lock cover (14) is placed onto the mounting base (12) and the two locking pins (6) enter through the two locking pin holes (8).

In use, the mounting base (12) is installed onto the side or top of a drawer by placing the mounting base (12) onto either the desired side or the top of the drawer and securing it in place by drilling four countersunk screws into the four countersunk screw holes (10) and through the drawer. With the mounting base (12) secured onto the drawer, to lock the drawer, the drawer is closed and the secure base lock cover (14) is placed onto the mounting base (12) with the padlock eye loop (4) passing through the hole for eye loop (2) and the two locking pins (6) passing through the two locking pin holes (8) located on the mounting base (12). At this time the locking device is in a locked position and is ready to be secured by placing a conventional padlock onto the padlock eye loop (4) and locking it. At this point the drawer is locked in a closed position.

With respect to the above description then, it is to be realized that the optimum dimensional relationships for the parts of the invention, to include variations in size, materials, shape, form, function and manner of operation, device and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A lock device for a drawer, said device being attached to either the left or right side or top of a drawer, said device comprising:
a mounting base having a padlock eye loop for the placement of a padlock;
a secure base lock cover, having two mounted pins which pass through said mounting base upon application, as well as a hole for said padlock eye loop to pass through upon application.
